(19) United States
(12) Patent Application Publication
(10) Pub. No.: US 2006/0106905 A1
(43) Pub. Date: May 18, 2006

(54) Method for reducing memory size in logarithmic number system arithmetic units

(76) Inventor: William A. Chren JR., Longmont, CO (US)

Correspondence Address: STMICROELECTRONICS, INC., MAIL STATION 2346, 1310 ELECTRONICS DRIVE, CARROLLTON, TX, 75006, US

(21) Appl. No.: 10/990,405

(22) Filed: Nov. 17, 2004

(51) Int. Cl. G06F 1/02

(52) U.S. Cl. 708/270

(57) ABSTRACT

A method for performing addition/subtraction on logarithmic number system (LNS) operands x and y that uses a single lookup table. The lookup table is populated by values of ln(1+exp(−α)) where α is an absolute value of difference of x and y. To perform an addition operation, the lookup table is accessed a single time and the lookup table output added to the largest of the input operands to produce the result. To perform a subtraction operation the addition lookup table is successively addressed by left-shifted versions of α, the table outputs are accumulated, and accumulated lookup table output added to the largest of the input operands to produce the subtraction result.

### BACKGROUND OF THE INVENTION

1. Field of the Invention

The present invention relates, in general, to computational hardware, and, more particularly, to software, systems and methods for reducing memory requirements in logarithmic number system arithmetic logic units (ALUs).

2. Relevant Background

The logarithmic number system (LNS) has found widespread use in digital signal processing applications in which multiplication and division are predominant operations. LNS techniques are used in many digital signal processing (DSP) applications such as digital filters, two-dimensional digital filtering, Fast Fourier Transforms (FFTs), as well as a variety of other operations and applications. These types of operations are common in signal processing, video processing, audio processing, data transmission, and a wide variety of other applications.

The logarithmic number system allows multiplication and division operations to be performed by ordinary addition and subtraction operations. Because addition and subtraction can be performed efficiently by combinational logic, LNS implementations can enhance performance. Addition and subtraction logic can be implemented in an area efficient manner on integrated circuits, and programmable logic devices such as field programmable gate arrays (FPGAs). However, the operations of addition and subtraction in the logarithmic number system are slower. They are typically implemented with lookup tables which store pre-computed values of two special expressions.

A significant problem in the use of LNS for arithmetic units is the amount of memory required to implement operands of reasonable word length. In particular, the lookup tables each have 2ⁿ entries for operands with n-bit precision. Each entry holds an n-bit length value. Since there are two complete lookup tables to perform both addition and subtraction, the memory requirements of the lookup tables are prohibitive. Some have suggested sacrificing accuracy by using fewer entries and interpolating between entries, however, these solutions are computationally expensive and require the addition of computational logic to perform the interpolation. Hybrid solutions have also been proposed that use LNS only for multiplication/division, and conventional floating point arithmetic units to handle addition and subtraction. These hybrid solutions involve a significant increase in the computational logic as well as increased complexity in scheduling and coordination of execution when algorithms involve both floating point and LNS operations.

The LNS represents operands by their natural logarithm. That is, floating point operand β is represented as ln(β). Using operands of this form, multiplication and division are performed using addition and subtraction, e.g.,:
β₁·β₂ [symbol] ln(β₁)+ln(β₂),βᵢ≠0 (1)
β₁/β₂ [symbol] ln(β₁)−ln(β₂),βᵢ≠0 (2)

However, for addition and subtraction the anitlog or exponential of the logarithmic number system operands must first be computed, the addition/subtraction performed, and the result converted back to the logarithmic number system. In other words:
β₁±β₂ [symbol] ln(exp(ln(β₁))±(exp(ln(β₂)))=ln(exp(x)±exp(y)), (3)
where x and y denote the quantities ln(β₁) and ln(β₂), respectively. The addition/subtraction operation can be represented as:

$$\begin{matrix}ln ( exp ( x ) \pm exp ( y ) ) = ln [ exp ( x ) ( 1 \pm exp ( y - x ) ) ] & ( 4 ) \\ = x + ln ( 1 \pm exp ( y - x ) ) & ( 4.1 ) \\ = y + ln ( 1 \pm exp x - y ) ) & ( 4.2 )\end{matrix}$$

where in the last two relationships the exp(x) and exp(y) terms, respectively, have been factored out.

When x≧y, consider the relationship shown in 4.1, and when y≧x, consider the relationship shown in 4.2. Combining these two cases yields:
β₁±β₂ [symbol] ln(exp(x)±exp(y))=max(x,y)+ln(1±exp(−α)), (5)
where α=|x−y| (i.e., α=|(ln(β₁)−ln (β₂))|) is nonnegative.

A schematic of a conventional LNS adder/subtractor is shown in prior art FIG. 1. In a conventional implementation of LNS addition and subtraction the quantities ln(1±exp(−α)) are stored in two lookup tables, a first table 101 for addition having values determined from ln(1+exp(−α)) and a second table 102 for subtraction having values determined from ln(1−exp(−α)). While the exponential values can be estimated algorithmically, table lookup is significantly faster in most instances. The LNS adder/subtractor in FIG. 1 is implemented using a max circuit, adder, absolute value unit and two lookup tables.

The input values x and y denote the quantities ln(β₁) and ln(β₂). Component 107 performs a subtraction x−y and absolute value unit 105 generates the absolute value α of the subtraction result. The sense bit, also called a sign bit, which indicates whether the output of component 107 is positive or negative, is coupled as a select bit to multiplexer 109. The x and y values are coupled as input to multiplexer 109. In this manner, the output of multiplexer 109 is the maximum or largest of either x or y which is coupled as an input to adder 113.

The value α is used to select entries in lookup table 101 and lookup table 102. An addition/subtraction signal is used to select either the addition lookup table 101 output or the subtraction lookup table 102 output and couple the selected lookup table output to adder 113. Lookup tables 101 and 102 are typically large and so consume a large amount of space in integrated circuit implementations or consume significant quantities of limited on-chip memory in FPGA solutions. Because one table is required for addition and a separate, equally sized table is required for subtraction the lookup tables are, in a sense, duplicated. A need exists for systems, methods, and computational hardware for performing logarithmic number system operations while reducing this storage requirement.

### SUMMARY OF THE INVENTION

Briefly stated, the present invention involves a method for performing addition/subtraction on logarithmic number system (LNS) operands x and y that uses a single lookup table. The lookup table is populated by values of ln(1+exp(−α)) where cl is the absolute value of the difference of x and y. To perform an addition operation, the lookup table is accessed a single time and the lookup table output added to the largest of the input operands to produce the result. To perform a subtraction operation the addition lookup table is successively addressed by left-shifted versions of (x and the table outputs are accumulated. The accumulated lookup table outputs are added to the largest of the input operands to produce the subtraction result.

In another aspect, the present invention comprises a math unit for performing LNS addition and subtraction comprising a single lookup table comprising a plurality of values indexed by a value α. A value α is determined by finding the absolute value of the difference of two LNS operands x and y. The lookup table values cumulatively describe a function ln(1+exp(−α)). The math unit is configured to perform an addition by addressing the lookup table a single time using α and adding the lookup table output to the largest of the LNS operands. The math unit is configured to perform a subtraction by successively addressing the lookup table using left-shifted versions of α. An accumulator accumulates the lookup table outputs and adds the accumulated output to the largest of the LNS operands to determine a result for the subtraction.

### BRIEF DESCRIPTION OF THE DRAWINGS

FIG. 1 shows a prior art implementation of a math unit;

FIG. 2 shows an implementation of a math unit in which the present invention is implemented;

FIG. 3 illustrates simulated error results produced by an implementation of the present invention; and

FIG. 4 illustrates an enlarged view of the simulated error results shown in FIG. 3.

### DETAILED DESCRIPTION OF THE PREFERRED EMBODIMENTS

The present invention is illustrated and described in terms of a system and method that computes the sum and/or difference of two values represented in a logarithmic number system (LNS) and outputs a LNS value indicative of the computed sum and/or difference. Although the present invention is illustrated and described in terms of an adder/subtractor, it should be understood that the unit may be integrated with other logic such as multiply/divide logic, logic to perform specific functions such as exponentials, square roots, and the like. Moreover, the present invention may be implemented in a variety of special-purpose and general-purpose applications such as digital signal processing, image processing, audio processing, and the like.

The present invention recognizes that:
1=(1−x)(1+x)(1+x²)(1+x⁴)(1+x⁸) . . . , |x|<1. (6)
Dividing this relationship through by 1−x and taking the natural logarithm of both sides of the equation transforms the relationship to:
ln(1−x)=−ln(1+x)−ln(1+x²)−ln(1+x⁴)−ln(1+x⁸)− . . . , |x|<1. (7)

Letting x=exp(−α) transforms the relationship to:
ln(1−exp(α))=−ln(1+exp(−α))−ln(1+exp(−2α))−ln(1+exp(−4α))−ln(1+exp(−8α))− . . . , α>0. (8)

The term ln(1−(exp(−α)) describes the values held in a subtraction lookup table of a conventional math unit implementation, whereas the terms−ln(1+exp(−α))−ln(1+exp(−2α))−ln(1+exp(−4α))−ln(1+exp(−8α)) describe values that would be held in an addition lookup table and accessed by left-shifted values of α. Hence, relationship (8) shows that the subtraction lookup table contents can be computed by a difference of addition lookup table outputs. In the specific implementation herein, the addition lookup table is successively addressed by left-shifted versions of α. In a binary representation of α left-shifting by one bit has the effect of multiplying α by two. Each time the lookup table value is accessed and accumulated, the result of equation (8) becomes incrementally more accurate. The number of successive lookup table accesses can be up to the number of bits in the value of a although fewer accesses will often provide a suitably accurate approximation. In a particular example nine terms in the sum are used, requiring nine successive lookup table accesses. The table outputs are accumulated to generate the subtraction result.

FIG. 2 shows a schematic of an addition/subtraction unit in accordance with the present invention. As shown in FIG. 2, only a single lookup table 201 is required. The absolute value ce is determined by subtractor 107 and absolute value component 105 as described above and coupled to a shift register 205. The sense bit is used to select either the x or y value by multiplexer 109 and couple the selected value to adder 113.

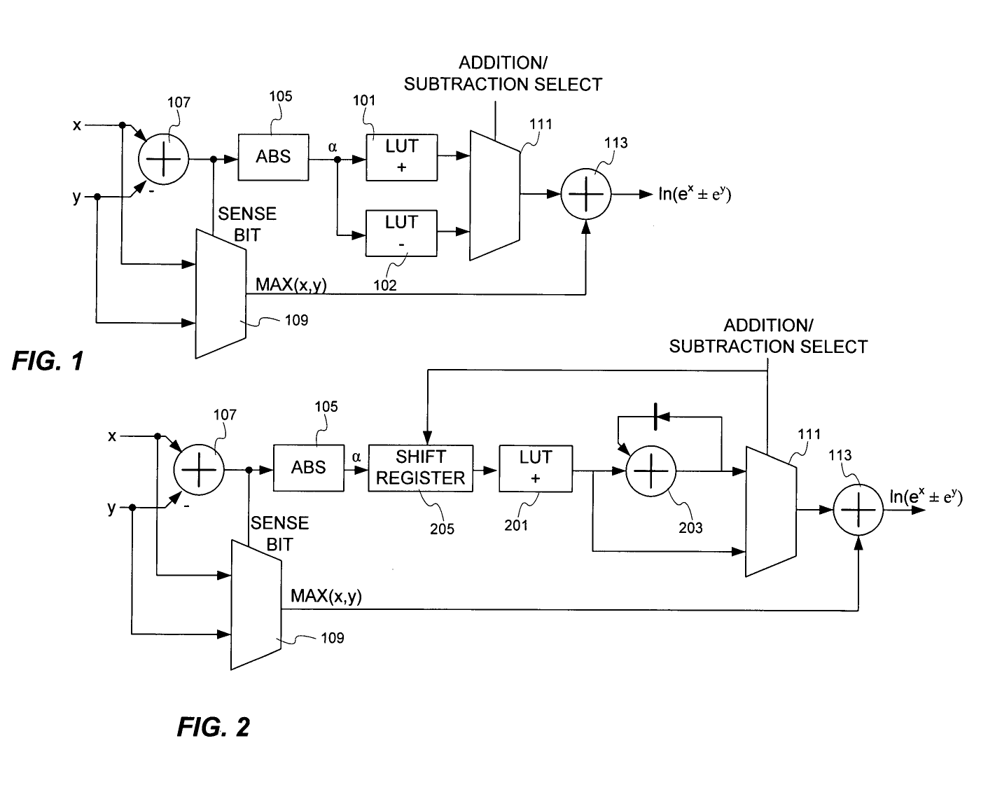

Unlike the conventional implementation shown in FIG. 1, the present invention uses the addition/subtraction select signal to control not only multiplexer 111, but also to cause shift register 205 to shift the α value therein by one bit, which multiplies the value of α by two for each successive shift. As a result shift register 205 will output a series of values:
[α, 2α, 4α, . . . 2ⁿα]
Each value output from shift register 205 will access an entry in lookup table 201. IN the case of subtraction operations the successive output values are applied to accumulator 203 which has an accumulated output coupled as one input to multiplexer 111. For addition operations a single output of LUT 201 is sufficient and is applied to multiplexer 111. The addition/subtraction select signal controls multiplexer 111 to couple the appropriate input to adder 113. Adder 113 combines the selected input with the selected value from multiplexer 109 to produce the result.

It should be noted that the particular implementation presented herein is based on the relationship shown in equation (6) in which each term includes a factor that increases by a power of two. This translates in to each term in the corresponding LNS implementation increasing by a factor of two which, in turn, allows the shift register to be conveniently used to manipulate the value of α for each successive access. It is contemplated that other implementations of the basic teaching of the present invention might involve equations that are different from that shown in equation (6) and that corresponding changes would be necessary to compute the a values for each successive access. For example, rather than a shift register 205, one might have a multiplier unit that multiplied each term by a series of constants (e.g., 3, 5, 7 . . . ), although such implementations may be more complex and no more useful than the particular embodiments described herein.

While successively accessing the lookup table 201 and accumulating the result is slower than a single access required by the implementation of FIG. 1, the present invention requires significantly less memory. This tradeoff can be quite advantageous in applications in which memory is not available or is in short supply.

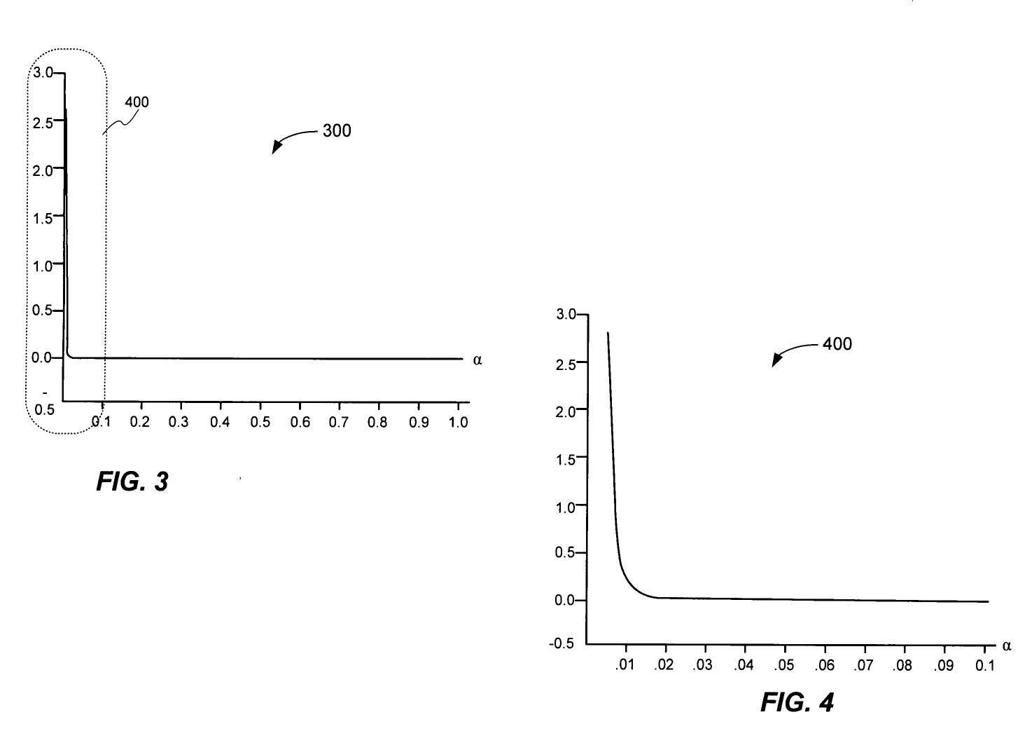

FIG. 3 and FIG. 4 illustrate curves 300 and 400 showing error incurred by the present invention as compared to conventional implementations shown in FIG. 1. FIG. 3 and FIG. 4 illustrate the error that results when nine terms are used in the sum, which would require nine sequential lookup table access/accumulation cycles to implement. In FIG. 3 and FIG. 4, the vertical axis represent error magnitude in percent and the horizontal axis represents α. The error is very small for all values of α>0.01. FIG. 4 illustrates an view of the portion 400 of the error simulation of FIG. 3. Such small α values correspond to instances when x and y are approximately equal.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method of computing a mathematical function of logarithmic number system (LNS) operands x and y in a computing device, the method comprising:
populating a lookup table with values;
providing a value a from an absolute value of difference of x and y;
when performing an addition operation, accessing the lookup table a single time using the value α and adding the lookup table output added to the largest of the input operands to produce the addition result; and
when performing a subtraction operation accessing the lookup table a plurality of times with different versions of the value α, accumulating the lookup table outputs, and adding the largest of the input operands to the accumulated lookup table outputs to produce the subtraction result.

2. The method of claim 1 wherein the different versions of a are determined by left-shifted versions of α.

3. The method of claim 1 wherein the different versions of a are multiples of α.

4. The method of claim 1 wherein the lookup table comprises a plurality of entries indexed by α and each entry holds a predetermined value ln(1+exp(−α)).

5. The method of claim 1 wherein the act of performing a subtraction comprises accessing the lookup table n times using a series [α, 2α, 4α, . . . 2ⁿα].

6. The method of claim 1 wherein the act of performing a subtraction comprises accessing the lookup table at least nine times each with a different version of α.

7. The method of claim 1 further comprising:
providing an addition/subtraction select signal;
using the addition/subtraction select signal to selectively couple one of either the lookup table output or the accumulated lookup table output to an adder; and
using the addition/subtraction signal to generate the different versions of the value α.

8. The method of claim 1 wherein the number of times that the lookup table is accessed when performing a subtraction is selected to satisfy preselected error requirements.

9. A computing device implementing the method of claim 1.

10. A digital signal processor implementing the method of claim 1.

11. A math unit for performing a function on two logarithmic number system (LNS) operands x and y, the math unit comprising:
a component for determining a value α by finding the absolute value of the difference of two LNS operands x and y;
an address generator coupled to receive α and generate a plurality of address values from α;
a lookup table comprising a plurality of entries, wherein a value of a selected entry is output in response to an address identifying the selected entry;
a first selector for selectively coupling either a or the plurality of addresses generated from a to an input of an adder; and
a second selector for selectively coupling the largest of the two LNS operands x and y to an input of the adder, wherein an output of the adder is a LNS result of a function of the two LNS operands.

12. The math unit of claim 11 wherein x and y are LNS representations of floating point values β₁ and β₂, respectively and the function implemented by the math unit comprises β₁±β₂ [symbol] ln(exp(ln(β₁))±(exp(ln(β₂)))=ln(exp(x)±exp(y)).

13. The math unit of claim 11 wherein the lookup table values cumulatively describe a function ln(1+exp(−α)).

14. The math unit of claim 11 wherein the math unit is configured to perform an addition by addressing the lookup table a single time using a and adding the lookup table output to the largest of the LNS operands.

15. The math unit of claim 14 wherein the math unit is configured to perform a subtraction by successively addressing the lookup table.

16. The math unit of claim 11 wherein the address generator comprises a shift register coupled to receive α and the plurality of address values comprise left-shifted versions of α.

17. The math unit of claim 11 wherein the address generator comprises a shift register coupled to receive α and the plurality of address values comprise multiples of α.

18. A digital signal processor comprising:
a math unit for performing a function on a first LNS operand and a second LNS operand;
an absolute value unit within the math unit for determining a value a by finding the absolute value of the difference of the first and second LNS operands;
a lookup table comprising a plurality of entries, wherein a value of a selected entry is output from the lookup table in response to an address identifying the selected entry;
a first selector for selectively coupling either α or the plurality of addresses generated from α to an input of an adder; and
a second selector for selectively coupling the largest of the two LNS operands x and y to an input of the adder, wherein an output of the adder is a LNS result of a function of the first and second LNS operands.
